(19) United States
(12) Patent Application Publication
(10) Pub. No.: US 2012/0310857 A1
(43) Pub. Date: Dec. 6, 2012

(54) FACTOR-BASED MEASURING OF SIMILARITY BETWEEN FINANCIAL INSTRUMENTS

(75) Inventors: Nathan Joseph NASSIF, Encinitas, CA (US); Michael MARKOV, Short Hills, NJ (US); Michael CHIDLOVSKY, Millburn, NJ (US); Alexey PANCHECKHA, Glen Rock, NJ (US)

(73) Assignee: Markov Processes International, LLC, Summit, NJ (US)

(21) Appl. No.: 13/484,569

(22) Filed: May 31, 2012

Related U.S. Application Data
(60) Provisional application No. 61/493,704, filed on Jun. 6, 2011.

(51) Int. Cl. G06Q 40/06

(52) U.S. Cl. 705/36 R

(57) ABSTRACT

A system and method for factor-based measuring of similarity between financial instruments are described. The method including selecting a model for factor intersection calculation of a two or more of financial instruments, the model including a plurality of factors; determining factor exposure values for first and second financial instruments on each of the factors; determining a proximity between the factor exposure values based on the selected model; and calculating a factor intersection result between the factor exposure values, wherein the factor intersection result includes at least one of an overlap amount and a non-overlap amount.

### PRIORITY CLAIM

The present application claims priority to U.S. Provisional Application Ser. No. 61/493,704 filed on Jun. 6, 2011, the entire disclosure of which is incorporated herewith by reference.

### BACKGROUND OF THE INVENTION

When making investment selection and allocation decisions among various financial instruments, such as individual securities or portfolios, it is important to understand how these instruments relate to each other, how similar or dissimilar they are. For example, if two instruments, or securities contained therein, represent the same economic sector, style or have a similar quality-duration profile, they may not provide the desired diversification and risk reduction in a portfolio.

If these instruments represent portfolios of stocks, one could compare closeness of their holdings. But holdings either may not be readily available or difficult/impossible to compare and/or relate to each other. In such a case, alternatively, one could use prices or returns of instruments to compute various types of correlation measures between pairs of instruments. Although correlation statistic measures similarity of mutual behavior or co-movement of financial instruments, it does not reflect the mutual concentration, i.e., the degree of closeness of their fundamental or economic properties. Knowledge of the latter is extremely important in periods of economic shocks and certain extreme segment or sector-specific events.

### BRIEF DESCRIPTION OF THE DRAWINGS

FIG. 1 shows an exemplary embodiment of a system for measuring similarities between financial instruments according to the present invention.

FIG. 2A shows an exemplary embodiment of a method for measuring similarities between financial instruments according to the present invention.

FIG. 2B shows an exemplary embodiment of a method for applying factor intersection results according to the present invention.

FIG. 3 is a simple illustration of factor intersections projected through time in an area chart according to the present invention.

FIG. 4 shows an exemplary graph of intersection of one financial instrument versus another financial instrument according to the present invention.

FIG. 5 shows an exemplary graph of portfolio intersection projected onto a map according to the present invention.

### DETAILED DESCRIPTION

The present invention may be further understood with reference to the following description and the appended drawings, wherein like elements are referred to with the same reference numerals. The present invention relates to systems and methods for quantifying similarities between various financial instruments. Specifically, the exemplary systems and methods described herein relate to measuring a degree of similarity between several financial instruments using a “factor intersection” metric. The factor intersection metric may measure the closeness of factor exposures to these financial instruments, as derived by similar (or same) factor models.

As will be described in greater details below, factor intersection calculations options may be determined based on specifications of a selected factor model. Exemplary factor models may include financial multi-factor models and optimizations. Accordingly, factor intersection measurements may be analyzed as an aggregate over all factors and all time intervals, or alternative, over any subset of factors and/or time intervals. Furthermore, the exemplary embodiments described herein allow for these factor intersection measurements to be projected, visualized and used as input to any number of other investment analyses and procedures. For example, factor intersection methods may be used as objective functions in a multi-criteria financial optimization with asset allocation and portfolio construction processes.

While the exemplary embodiments described throughout the specification apply factor intersection measurements to multi-factor modeling in finance, the systems and methods are not limited to financial applications. For instance, some elements of the exemplary embodiments may be applied to other areas of finance, and in a broader sense, may even be applied more generically to factor modeling outside of finance. Accordingly, the exemplary factor intersection systems and methods and derivations thereof may be utilized within various financial analysis techniques, as well as within other domains.

One alternative application of intersection and overlap calculations may be within the area of holdings-based analysis. However, unlike holdings-based analysis that incorporates overlaps with real securities across multiple portfolios, factor intersection may not rely on holdings. As noted above, factor intersection analysis may rely on factor exposures generated by multi-factor models having their own unique dimensions and considerations that use multiple factor intersection calculations.

The similarity measurements computed by the exemplary systems and methods described herein may reflect measure correlation statistics such as mutual concentration between financial instruments. Mutual concentration may be described as a degree of closeness in fundamental and/or economic properties between various financial instruments. Such properties of financial instruments may be derived through the deployment of factor models (e.g., a statistical technique designed to explain the behavior of instruments as a function of various common economic and market factors). For example, for an equity portfolio, a factor model may generate a portfolio of generic broad market indices that closely mimics the performance of the original portfolio made up of individual stocks (e.g., a factor portfolio). An alternative factor model could provide sensitivities, or exposures, of the portfolio to various exogenous economic factors such as money supply, unemployment rate, industrial production, etc. By comparing such exposures for a group of equity portfolios one may better understand what behavior to expect from a group of portfolios in different economic and market scenarios. Specifically, one may determine any similarities and dissimilarities between portfolios.

Factor intersection may rely on factor exposures generated by a factor model. For instance, factor exposures may be represented by linear factor models such as:

$${R}_{i} ( t ) ≅ {α}_{i} + {\sum }_{k = 1}^{N} {w}_{i , k} * {ϕ}_{k} ( t )$$

According to this example, exposures w_{i,k} link the returns Rᵢ(t), or a function thereof, of a financial instrument Fᵢ over different moments of time t and returns of factors (_{↓}k(t) of the same period of time, wherein aᵢ denotes an optional intercept.

Factor exposure estimates generated from models, such as the example above, may greatly assist investment practitioners in making informed portfolio, asset allocation, risk, and investment decisions. As a note, “factors” (e.g., “regressors”, “independent variables”, “explanatory variables”, etc.) may consist of generic market indices, economic sectors, country indices, currencies, and econometric time series. The range of financial instruments may vary from individual securities to portfolios to complex contracts on such securities called derivatives. In some cases financial instruments may be used as factors within the model.

A wide set of modeling techniques may be utilized to estimate factor exposures of this form, such as, for instance, linear and non-linear regressions, Kalman filter, etc. Such a model may also be arbitrarily created by a person and represent his or her individual expert opinion. Nonlinear models may be employed as well. As a result of such an estimation, factor exposures may be time-varying and represent time-series w_{i,k}(t).

Additional factor models in finance may include the Capital Asset Pricing Model (“CAPM”) and Arbitrage Pricing Theory (“APT”), respectively. These models allow for a large number of factors that can influence security returns. Thus, the multi-factor CAPM model may be described using the following equation:

$${R}_{i} ( t ) - {R}_{f} ( t ) ≅ {α}_{i} + {\sum }_{k = 1}^{N} {β}_{i , k} * ( {r}_{k} ( t ) - {R}_{f} ( t ) )$$

According to this example, Rⁱ(t) represents time series of investment returns (either security or portfolio of securities), rₖ(t) represents returns on the market portfolio as well as changes in other factors, and R_{f}(t) represents returns on a risk-free instrument.

An exemplary multi-factor APT model may be written in the following form:

$${R}_{i} ( t ) ≅ {α}_{i} + {\sum }_{k = 1}^{N} {β}_{i , k} * {I}_{k} ( t )$$

According to this example, Iₖ(t) may be chosen to be any number of major economic factors that influence security returns (e.g., industrial production, inflation, interest rates, business cycle, etc.).

One of the most effective multi-factor models for analyses of investment portfolios may utilize Returns Based Style Analysis (“RBSA”). In the RBSA model, a set of linear constraints may be added to improve the interpretation and enhance the quality of parameter estimation, such as in the follow form:

$${R}_{i} ( t ) ≅ {α}_{i} + {\sum }_{k = 1}^{N} {β}_{i , k} * {r}_{k} ( t ) ; where {\sum }_{k = 1}^{N} {β}_{i , k} = 1 and {β}_{i , k} \geq 0$$

In this exemplary model, rₖ(t) represent periodic returns of N generic market indices, such as, for example, bonds, equities, economic sectors, country indices, currencies, etc. Accordingly, for instance, twelve generic asset indices may used to represent possible areas of investment.

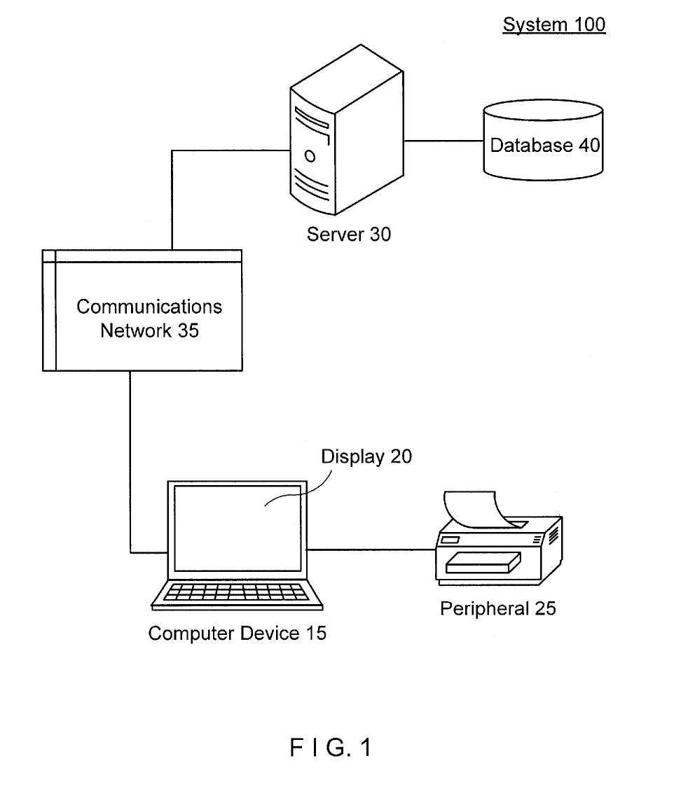

FIG. 1 shows an exemplary embodiment of a system 100 for measuring similarities between financial instruments according to the present invention. The system 100 may include a computer device 15 having a display 20, a memory arrangement (not pictured) and a processor (not pictured). The computer device 15 may be in communication with a peripheral device 25, as well as a communication network 35. The system 100 may further include a server 30 and a database 40, each in communication with the communication network 35.

As discussed above, the exemplary system 100 may utilize factor intersection metrics in order to provide additional information that can enhance portfolio, asset allocation, risk management, and general investment decisions. These enhancements may be in the form of adding visibility to potential overlaps and redundancies within a portfolio of financial instruments. In addition, factor intersections may allow for the system 100 to also provide important inputs in model specification for portfolio optimization and asset allocation frameworks. For example, the system 100 may use factor intersection as a part of the objective function in such an optimization problem to minimize the intersection of portfolios within an allocation.

As discussed above, the exemplary systems and methods described herein utilizes factor intersection to measure the closeness of two or more financial instruments. This closeness may be determined by measuring the closeness of their factor exposures as derived by the same or similar factor models. Accordingly, such a measure may be computed as an aggregate, over all factors and all time intervals, or alternatively, over any subset of either factors or time intervals.

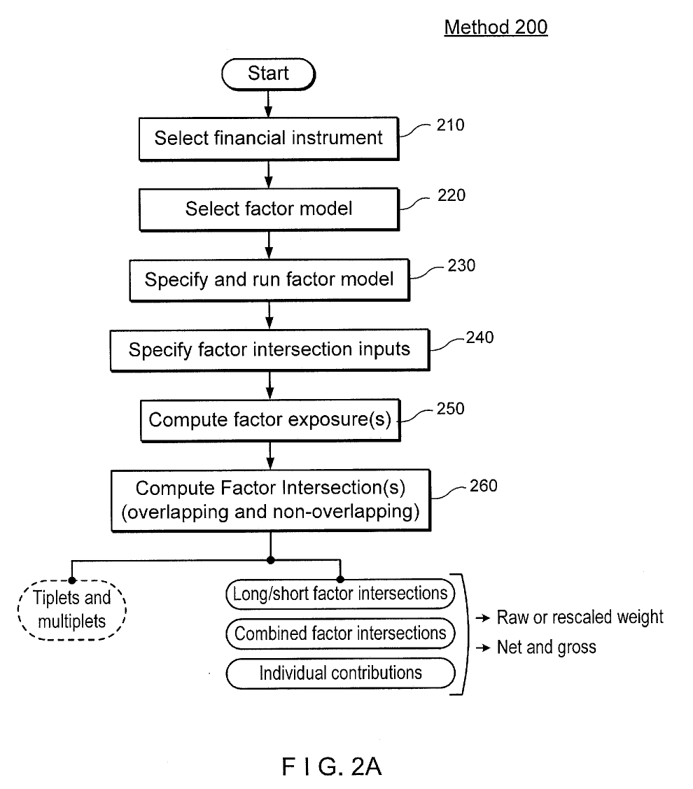

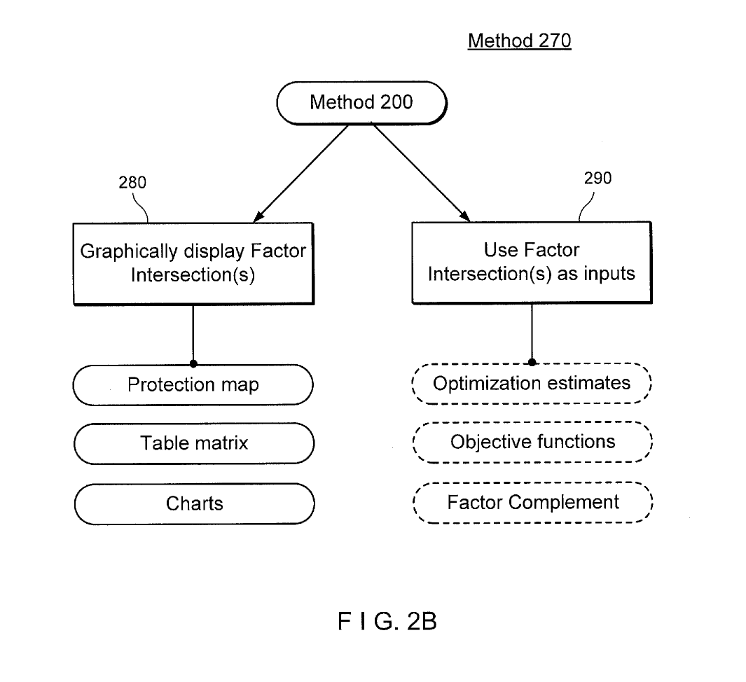

FIG. 2A shows an exemplary embodiment of a method 200 for measuring similarities between financial instruments according to the present invention. As will be described in greater details below, the exemplary method 200 may be used to generate factor intersection results for analysis (e.g., visualization tools) and applications (e.g., as data inputs).

In step 210, the method 200 may select financial instruments to be analyzed using factor intersection. Specifically, at least two financial instruments may be selected in order to determine a closeness of factor exposures derived by financial multi-factor models.

In step 220, the method 200 may select a factor model. As noted above, the exemplary factor intersection analysis may be applied to a vast and diverse array of multi-factor models in finance, as well as other applications. Some of the more common factor models in finance may include a Capital Asset Pricing Model (“CAPM”) and an Arbitrage Pricing Theory (“APT”). Accordingly, these models allow for a large number of factors that can influence security returns. It should be noted that a wide set of modeling techniques may be implemented to estimate factor exposures. For instances, these techniques may include, but are not limited to, linear and non-linear regressions, Kalman filter, etc. Furthermore, such models may be arbitrarily created by an individual and represent the individual's expert opinion.

In step 230, the method 200 may specify and run the selected factor model. The specification of the factor model may include selecting factors (e.g., regressors, independent variables, explanatory variables, etc.). For instance, the factors may be comprised of generic market indices, economic sectors, country indices, currencies, econometric time series, etc. Financial instruments may be comprised of individual securities, portfolios, complex contracts on such securities called derivatives, etc. According to one exemplary embodiment, financial instruments may be used as the selected factors within the model.

The specification of the model may also include setting various parameters and constraints. For instance, a user may analyze a hedge fund and specify that the selected model should be unconstrained and account for significant leverage. There are numerous parameter settings and constraints depending on the type of model used, time period, etc.

The specification of the model may influences the type of factor intersection calculation option and inputs that are used. In the hedge fund example above, the long/short proprietary factor intersection calculation option would be used. Accordingly, once the model has been specified, the method 200 may then run the multi-factor.

In step 240, the method 200 may specify factor intersection inputs. The specification of factor intersection inputs may involve: (a) include and exclude factors post model run; (b) calculation options; and (c) time period and aggregation settings.

Selecting factors in this case may not relate to specifying and running the model, as the factors may only effect which factor exposures selected in the multi-factor model are applicable for the factor intersection analysis. In some cases, it may be desirable to consider the overlap of only a subset of the factors for which exposures are available. In the case where some factors are selected, only the selected factors may be considered in the intersection calculations. The deselected factors will appear with zero overlap. However, these deselected factors may still have been used in the calculations of the multi-factor model.

The selection of financial instruments may include, but is not limited to, mutual funds, benchmarks, peer group averages, etc. Accordingly, any financial instrument (e.g., proxy, etc.) may be shown in the table matrix, chart, etc. For example, a single mutual fund may be selected to show against other mutual funds and a relevant benchmark. Alternatively, all mutual funds in an analysis may be selected, and the factor intersections may be shown against all others. Any number of calculation options and analysis may be selected.

In addition, time interval settings may influence the period over which the factor intersections are calculated, projected, and graphically displayed. Aggregation settings may default to the highest frequency of a time series and relate directly to the multi-factor model specification. For example, if the time series are monthly data, then the multi-factor model and associated factor intersection analysis may produce monthly values. Any setting that aggregates multiple periods (e.g., 6-months) may average the factor intersection over all dates for which the overlap was calculated within the range.

In step 250, the method 200 may compute factor exposures. As noted above, there may be a wide range of multi-factor model types used in finance analysis. An exemplary multi-factor model for analyses of investment portfolios may be the Returns Based Style Analysis (“RBSA”). In the RBSA model, a set of linear constraints is added to improve the interpretation and enhance the quality of parameter estimation:

$${R}_{i} ( t ) ≅ {α}_{i} + {\sum }_{k = 1}^{N} {β}_{i , k} * {r}_{k} ( t ) ; where {\sum }_{k = 1}^{N} {β}_{i , k} = 1 and {β}_{i , k} \geq 0$$

In such a model, rₖ(t)| represent periodic returns of N generic market indices such as bonds, equities, economic sectors, country indices, currencies, etc. For example, twelve generic asset indices may be used to represent possible areas of investment. Other CAPM or APT model frameworks may be used, including a dynamic style analysis model.

In step 260, the method 200 may compute factor intersection data. According to the exemplary embodiments described herein, there are multiple analysis options and applications of the computational results in the context of multi-factor models in finance. As will be outlined in greater detail below, these applications may include, but are not limited to, factor intersection computations for long-only asset based factor model, short-only asset based factor model, combined, gross, and adjustment options such as raw versus rescaled weights.

The factor intersection analysis and computations implicitly introduce the concept of a “Factor Intersection Portfolio” and “Non-Factor Intersection Portfolio.” Generalized formulas may also be included to emphasize that factor intersection analysis can be applied more broadly and extended to include multiplets and triplets. Furthermore, it should be noted that there are many extensions to the baseline calculations outlined herein. For instance, any number of adjustments by additional scaling factors, statistics, etc., may conceivably be applied within the factor intersection analysis and calculations. For example, factor intersection may be adjusted by a cross-validation measure to render the final result. While each and every adjustment may not initially articulated, however, one skilled in the art would understand the natural extensions to the various calculation options.

FIG. 2B shows an exemplary embodiment of a method 270 for applying factor intersection results following the performance of the above-mentioned method 200 according to the present invention. As discussed above, the raw factor intersection results may be applied in different ways, systems, etc., in step 290. In addition, or alternative, these results may be visualized and parsed in their own right in various displays in step 280.

As will be describe in greater detail below, step 280 may generate a factor intersection map based on the results from the method 200. Both the overlapping portion and non-overlapping portions may be projected for the “Factor Intersection Portfolios” and “Non-Intersection Portfolios,” respectively. Accordingly, these results may be projected in 2D and 3D spaces and a range of third dimensional attributes may conceivably affect attributes of the visualization (e.g., line, dot, etc.).

A factor intersection table matrix (Tables 1A and 1B below) may be a considered as an additional visualization of the data. Accordingly, calculations and analysis may be represented as a square matrix. For example, Tables 1A and 1B below are a sample visualization using a raw table matrix:

TABLE 1A

| | Overlap (weighted) Long Only, % | | | | |
|---|---|---|---|---|---|
| | Large | Large | Small | | |
| | Value | Growth | Value | Intermediate | International |
| | Fund | Fund | Fund | Bond Fund | Equity Fund |
| Large Value | 100.00 | 0.00 | 15.30 | 2.52 | 30.77 |
| Fund | | | | | |
| Large Growth | 0.00 | 100.00 | 58.67 | 0.00 | 7.89 |
| Fund | | | | | |
| Small Value | 15.30 | 58.67 | 100.00 | 1.63 | 7.89 |
| Fund | | | | | |
| Intermediate | 2.52 | 0.00 | 1.63 | 100.00 | 2.52 |
| Bond Fund | | | | | |
| International | 30.77 | 7.89 | 7.89 | 2.52 | 100.00 |
| Equity Fund | | | | | |
| Russell 1000 | 35.70 | 22.00 | 29.01 | 0.12 | 7.89 |
| Index | | | | | |

TABLE 1B

| | | | | | |
|---|---|---|---|---|---|
| Large Value Fund 1 | 1 | | | | |
| Large Growth Fund 2 | 0.00 | 2 | | | |
| Small Value Fund 3 | 15.30 | 58.67 | 3 | | |
| Intermediate Bond Fund 4 | 2.52 | 0.00 | 1.63 | 4 | |
| International Equity Fund 5 | 30.77 | 7.89 | 7.89 | 2.52 | 5 |

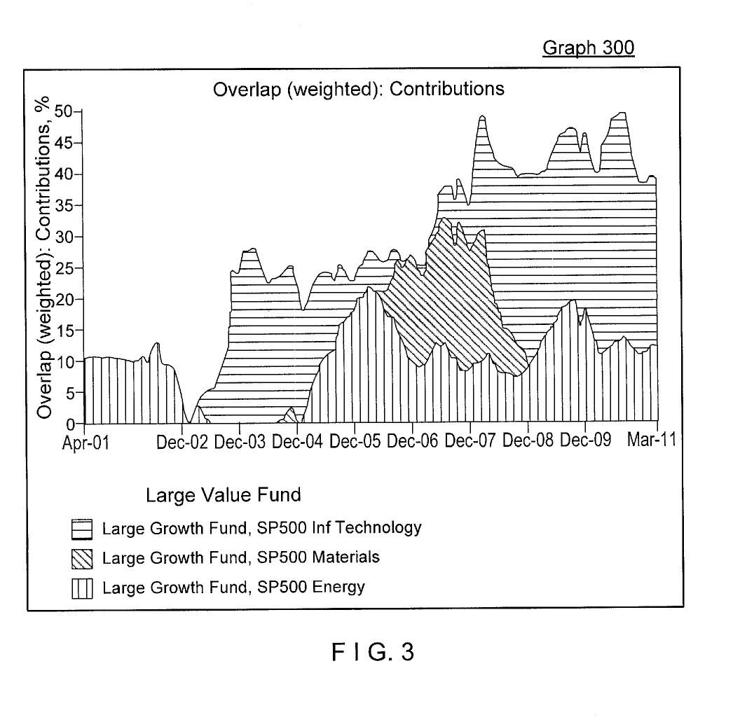

Furthermore, there are a range of conventional graphic displays that may illustrate this overlap, including, line charts, area charts, pie charts, combination charts, etc. For instance, graph 300 of FIG. 3 is a simple illustration of factor intersections projected through time in an area chart. Additional visualization example will be described below.

Step 290 may utilize the raw factor intersection results from the method 200 as an input to various applications and procedures. For example, the raw factor intersection data may be used within the multi-factor modeling process itself. Alternatively, the raw factor intersection data may be used to support multi-criteria financial optimizations as adjustment, scaling, direct inputs, and/or objective functions. In addition, factor intersections may also be used to calculate a “factor complement,” e.g., a measurement of dissimilarity of two or more instruments, or one minus factor intersection.

According to the exemplary systems and methods described herein, factor intersection calculation may quantify the amount of overlap for two financial instruments in terms of their common factor exposure estimates. For example, if financial instrument A's exposure to factor X is 20% and financial instrument B's exposure to factor X is 30%, then factor X intersection between A and B is the smallest of the two, i.e., 20%. This represents a single pair wise factor intersection metric, as shown in Table 3 below:

TABLE 3
Factor Intersection % per single Factor X

| | Fin. Instr. A | Fin. Instr. B |
|---|---|---|
| Fin. Instr. A | — | |
| Fin. Instr. B | 20 | — |

When an aggregate factor intersection is computed over all factors in the model, the following formula may be utilized:

$${O}_{ij} = {\sum }_{k = 1}^{N} min ( {w}_{i , k} , {w}_{j , k} )$$

According to this example, 0ᵢⱼ represents the factor intersection between financial instruments Fᵢ and Fⱼ; w_{i,k} and w_{j,k} represent exposures of financial instruments Fᵢ and Fⱼ correspondingly to the factor “k”. The total number of factors is N. Additional details in calculation related specifics will be provided below.

It should be noted that factor intersection may also be calculated, visualized, grouped and aggregated in other ways. Unlike the single factor intersection metric illustrated above, an investment practitioner may choose to quantify factor intersection across all factors used in the model in table matrix form. For instance, the example below sums the individual pair wise factor intersections for all factors used in the model and presents them in a table form, as such Table 4:

TABLE 4
Aggregate Factor Intersection % across all Factors

| | Fin. Instr. A | Fin. Instr. B | Fin. Instr. C | Fin. Instr. C |
|---|---|---|---|---|
| Fin. Instr. A | — | | | |
| Fin. Instr. B | 0 | — | | |
| Fin. Instr. C | 7 | 12 | — | |
| Fin. Instr. D | 5 | 15 | 20 | — |

According to this example, financial instrument C is shown to have an aggregate factor intersection exposure to financial instrument D of 20% across all factors used in the model. These calculations demonstrate that the intersection is a property of the pair of instruments Fᵢ and Fⱼ. In general, all possible intersections among a number of instruments may be represented as a square matrix and a wide range of calculation methodologies may then be applied within this context.

An exemplary square matrix may be represented by the following formula:

$${O}_{ij} = ( \begin{matrix}{O}_{11} & … & {O}_{L 1} \\ & & \\ {O}_{1 L} & … & {O}_{LL}\end{matrix} )$$

According to this example, L is a total number of financial instruments.

Factor intersection at both the single factor and aggregate levels may be thought of as constituting an “intersection portfolio.” For instance, representation of the intersection may be derived from individual contributions min(w_{↓}(i,k), w_{↓}(j,k))) of each factor “k” to the overall measure. Accordingly, these contributions may be interpreted as weights of an intersection portfolio. The non-overlapping portion of the above example may be thought of as a “non-intersection portfolio”. Both portions may be visualized and used in various ways.

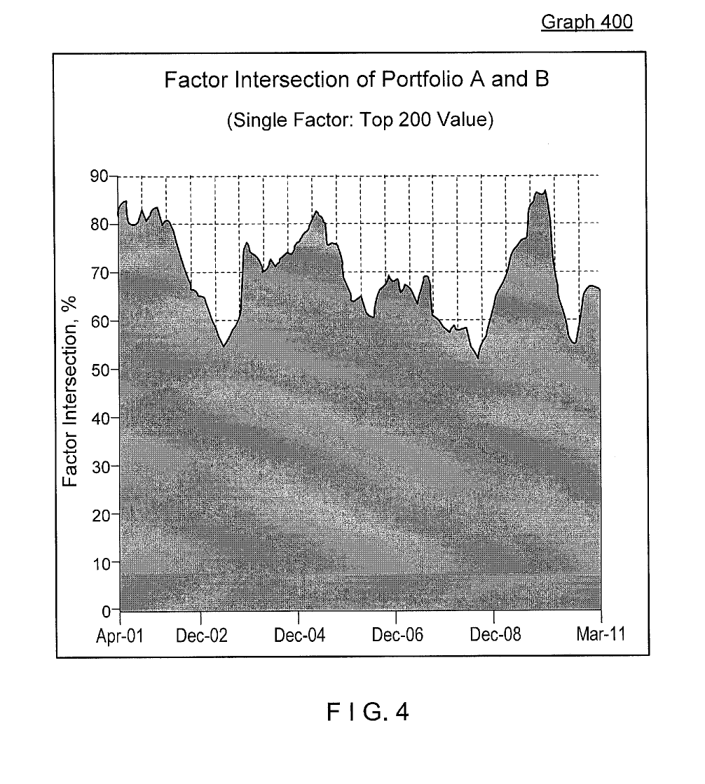

According to the exemplary embodiments described herein, the factor intersection systems and methods may be visualized using projections, graphical displays and any other visualization tool, such as maps and graphs. Examples of such visualization tools are described in FIGS. 3 and 4 below. Furthermore, factor intersection analysis may be visualized in any number of instruments, such as, but not limited to, table matrix layouts, line charts, combination charts, pie charts, etc.

FIG. 4 shows an exemplary graph 400 of intersection of one financial instrument (e.g., portfolio A) versus another financial instrument (e.g., portfolio B) according to the present invention. According to this example, these intersection portfolios may be calibrated by the actual dollar weights of the financial instruments within the investment portfolio and visualized across various time intervals. Thus, the graph 400 represents the intersection of financial instrument A versus financial instrument B for a single factor through time. In this exemplary scenario, the time interval is 120-months through March of 2011.

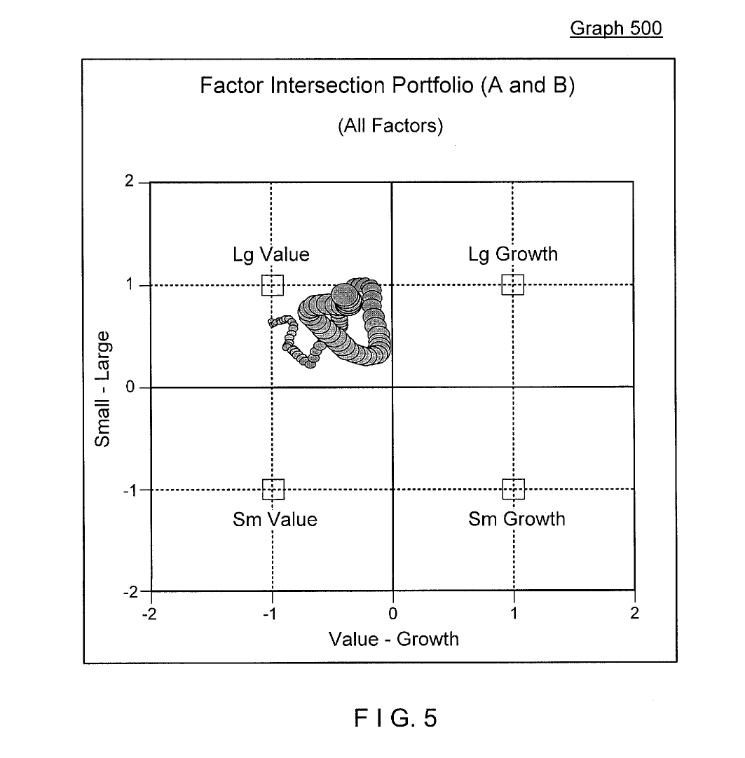

FIG. 5 shows an exemplary graph 500 of factor intersection of portfolios A and B projected onto a projection map according to the present invention. Specifically, the “intersection portfolio” can also be visualized and projected onto a map and shown through time.

According to this example, a projection operator may be generated for projecting the pair wise factor intersection exposures for two financial instruments onto a plane based upon a linear mapping. In the map illustrated in graph 500, the coordinates, as represented by factors used in the model, may be defined for the US equity market as follows:

X coord.=(Top 200 Growth+Small Growth)−(Top 200 Value+Small Value)

Y coord.=(Top 200 Growth+Top 200 Value)−(Small Growth+Small Value)

Therefore, for example, pair wise factor intersection exposures for a single point in time may equate to:

X coord.=(29+0)−(12+19)=−2

Y coord.=(29+12)−(0+19)=22

It may be noted that this information can also be plotted through time as shown the graph 500 and the size of the dots may represent any third dimensional attribute, such as the size of factor intersection.

As discussed above, factor intersection calculation options may be determined by the specifications of a model. For example, a factor model may include constraints on factor exposures, such as non-negativity (e.g., long-only), and budget exposures, such as in RBSA. These constraints may influence the type of factor exposure estimates generated by the model. Accordingly, the factor intersection algorithm used for these cases and many others may vary from the simple minimum of lesser two values listed above.

### Long-only Asset Based Factor Model (e.g., RBSA)

The following steps treat a case where the factor exposures are estimated using the RBSA model, such as where the sum of the factor exposures is non-negative and sum to 100%.

Step 1: Produce model factor exposures for all or select financial instruments and for selected period of time.

Step 2: Determine if the factor exposures should be rescaled (e.g., normalize sum of weights to 100%).

Step 3: Having the factor exposures for the selected financial instruments, then for each pair of financial instruments:

Loop through all factor exposure estimates. For each individual factor find the smaller of two financial instruments' factor exposure estimates.

Sum all of these (smaller) factor intersection exposure estimates and this is the final factor intersection.

### Long-Short Asset Based Factor Model

Outlined below is a more complicated scenario. Specifically, factor exposures in this case may either be positive or negative given the parameter settings in the model. According to this scenario, the long (e.g., positive) and short (e.g., negative) positions are treated separately, as if each financial instrument has two sets of factor exposures: positive (long) and negative (short). An exemplary method of performing the calculation steps may be as follows:

Step 1: For each selected financial instrument, factor exposures are split into two arrays: positive factor exposure estimates and negative factor exposure estimates. This means that there are two portfolios for each financial instrument consisting of long (positive) and short (negative) factor exposures.

Step 2: Determine if the factor exposures are to be rescaled. If so, both the long and short factor exposures should be treated separately and normalized to 100% respectively.

Step 3: Factor intersection exposure estimates between two financial instruments are computed separately between their long portfolios and short portfolios respectively.

For the short portfolio, the “smaller factor exposure” is the one with the smaller absolute value.

In this case, there are two factor intersection exposure estimates for the long (positive) and short (negative) components.

Step 4: In cases where either the long or short sides are empty (e.g., the factor intersection exposure estimates sum to 0%), then the following steps may be taken:

memorization of which side is empty;

do not rescale;

do not calculate factor intersection exposure estimates; and

record zero value for the factor intersection exposure estimate.

Step 5: These two numbers may then be combined into a Net or Gross basis into one measure as follows:

“Factor intersection” is the sum of two intersections (positive) value for the long side plus (negative) value for the short side.

“Long only factor intersection” is the long side factor intersection exposure

“Short only factor intersection” is the absolute value of short side factor intersection

“Gross factor intersection” is the:
sum of absolute values for the long and short factor intersection (without rescaling); and
one half of the sum of absolute values for the long and short factor intersection exposures (with rescaling).

Step 6: Factor intersection can also be extended on triplets and multiplets of instruments. For example, the following formula represents an intersection measure of a triplet of instruments:

$${O}_{ijl} = {\sum }_{k = 1}^{N} min ( {w}_{i , k} , {w}_{j , k} , {w}_{l , k )} )$$

Step 7: A measure of dissimilarity of two or more instruments (e.g., Factor Complement) may then be computed as one minus factor intersection in each of the cases above.

Step 8: An exemplary formula for illustrating the factor intersection may be as follows:

$${O}_{ij} = {\sum }_{k = 1}^{N} min ( {w}_{i , k} , {w}_{j , k} )$$

The exemplary may be is constructed from contributions of individual factors min(w_{i,k}, w_{j,k}). Step #5 discussed above illustrates the fact that these contributions may be grouped into subsets with factor intersection numbers calculated for each group independently and an overall factor intersection number computed as a weighted sum of groups' factor intersections.

The following may be examples of this procedure:

a. Long-Short portfolios as illustrated in the item #5

b. Contribution to factor intersection—individual contribution of each factor

c. Treatment of APT-like factor models where individual factors can be grouped in various ways that reflect the economic meaning of factors or the user's view of the factors including but not limited to market factors, alpha factors, and risk factors. The weighting schema used to compute an overall factor intersection may reflect a user's view or economic rational respectively.

The present invention has been described with reference to specific exemplary embodiments thereof. It will, however, be evident that various modifications and changes may be made thereto without departing from the broadest spirit and scope of the present invention as set forth in the disclosure herein. Accordingly, the specification and drawings are to be regarded in an illustrative rather than restrictive sense.

1. A method, comprising:
selecting a model for factor intersection calculation of a two or more of financial instruments, the model including a plurality of factors;
determining factor exposure values for first and second financial instruments on each of the factors;
determining a proximity between the factor exposure values based on the selected model; and
calculating a factor intersection result between the factor exposure values, wherein the factor intersection result includes at least one of an overlap amount and a non-overlap amount.

2. The method of claim 1, further comprising:
providing the calculated factor intersection result in a visual representation.

3. The method of claim 2, wherein the visual representation is one of a projection map, a table matrix, a line chart, an area chart, a pie chart, and a combination chart.

4. The method of claim 1, further comprising:
providing the calculated factor intersection result as an input to a further application.

5. The method of claim 4, wherein the further application is one of an optimization estimate, an objective function, and a factor complement.

6. The method of claim 1, wherein the proximity between the first and second factor exposures is determined as an aggregate over each of the factors during a plurality of time intervals.

7. The method of claim 1, wherein the proximity between the first and second factor exposures is determined as a subset of the factors during at least one time interval.

8. The method of claim 1, wherein the selected model is a long-only asset based factor model, and the visual representation of the calculated over amount is provided as a table matrix.

9. The method of claim 8, further comprising:
determining, for each of the factors, a smaller value from of the factor exposure values from the first and second financial instruments; and
computing a final factor intersection based on a sum of all of the determined smaller values.

10. The method of claim 1, wherein the selected model is a long-short asset based factor model, and the visual representation of the calculated over amount is provided as a projection map.

11. The method of claim 10, further comprising:
determining a positive factor exposure estimate for each financial instrument;
determining a negative factor exposure estimate for each financial instrument;
positioning linear vertices on the map; and
generating projection operator through projecting the factor intersection exposures for two financial instruments onto the map based upon a linear mapping.

12. The method of claim 11, further comprising:
selecting a subset of instruments to project onto the projection map during at least one time interval.

13. A computer readable non-transient storage medium including a set of instructions executable by a processor, the set of instructions operable to:
select a model for factor intersection calculation of two or more financial instruments, the model including a plurality of factors;
determine factor exposure values for first and second financial instruments on each of the factors;
determine a proximity between the factor exposure values based on the selected model; and
calculate a factor intersection result between the factor exposure values, wherein the factor intersection result includes at least one of an overlap amount and a non-overlap amount.

14. The medium of claim 13, wherein the selected model is a long-only asset based factor model, and the visual representation of the calculated over amount is provided as a table matrix and the set of instructions are further operable to:
determine, for each of the factors, a smaller value from of the factor exposure values from the first and second financial instruments; and
compute a final factor intersection based on a sum of all of the determined smaller values.

15. The medium of claim 13, wherein the selected model is a long-short asset based factor model, and the visual representation of the calculated over amount is provided as a projection map and the set of instructions are further operable to:
determine a positive factor exposure estimate for each financial instrument;
determine a negative factor exposure estimate for each financial instrument;
position linear vertices on the map; and
generate projection operator through projecting the factor intersection exposures for two financial instruments onto the map based upon a linear mapping.

16. A system for quantifying similarities between various financial instruments, comprising:
a non-transient memory arrangement storing data; and
a processor performing instructions stored as data on the non-transient memory,
wherein the instructions include:
selecting a model for factor intersection calculation of two or more financial instruments, the model including a plurality of factors;
determining factor exposure values for first and second financial instruments on each of the factors;
determining a proximity between the factor exposure values based on the selected model;
calculating a factor intersection result between the factor exposure values, wherein the factor intersection result includes at least one of an overlap amount and a non-overlap amount.

17. The system of claim 16, wherein the instructions further include:
providing the calculated factor intersection result in a visual representation, the visual representation is one of a projection map, a table matrix, a line chart, an area chart, a pie chart, and a combination chart.

18. The system of claim 16, wherein the instructions further include:
providing the calculated factor intersection result as an input to a further application, the further application is one of an optimization estimate, an objective function, and a factor complement.

19. The system of claim 16, wherein the selected model is a long-only asset based factor model, and the visual representation of the calculated over amount is provided as a table matrix.

20. The system of claim 16, wherein the selected model is a long-short asset based factor model, and the visual representation of the calculated over amount is provided as a projection map.
